(19) United States
(12) Patent Application Publication
(10) Pub. No.: US 2011/0055679 A1
(43) Pub. Date: Mar. 3, 2011

(54) DOCUMENT LINK CONVERTING SERVER, DOCUMENT LINK CONVERTING SYSTEM AND DOCUMENT LINK CONVERTING METHOD

(75) Inventor: Yoshiko SHIIMORI, Tokyo (JP)

(73) Assignee: FUJIFILM Corporation, Tokyo (JP)

(21) Appl. No.: 12/874,051

(22) Filed: Sep. 1, 2010

(30) Foreign Application Priority Data
Sep. 1, 2009 (JP) JP2009-201731

(51) Int. Cl. G06F 17/00

(52) U.S. Cl. 715/208

(57) ABSTRACT

In order to enable a mobile terminal where software necessary to open a document file is not installed to display a document linked from a markup document such as an HTML document, a document link converting system converts an HTML of a web page requested by a mobile terminal in accordance with a terminal type of the mobile terminal which requests an access to the web page, and sends the converted HTML to the mobile terminal. When a document is specified by the mobile terminal, the document link converting system sends an application for browsing the document to the mobile terminal, creates an image for browsing the specified document, and sends the created image to the mobile terminal. The mobile terminal displays the image for browsing with using the received application for browsing the document.

### BACKGROUND OF THE INVENTION

1. Field of the Invention

The presently disclosed subject matter relates to a document link converting server, a document link converting system and a document link converting method. In particular, it relates to a document link converting server, a document link converting system and a document link converting method configured to allow a user to browse a document file linked from a content file, such as a HyperText Markup Language (HTML) file.

2. Description of the Related Art

A technique optimizing an HTML document for a cellular phone when the HTML document is browsed by the a cellular phone is known to those skilled in the art.

For example, Japanese Patent Application Laid-Open No. 2002-351736 discloses a technique which, in parallel with adding link information indicating a link to another page to each page associated with segmented pieces of document data, provides a title of the other page, a phrase disposed in the head of the other page, or a phrase representing the other page. The technique disclosed in Japanese Patent Application Laid-Open No. 2002-351736 enables a user to easily browse the document data even if the document data is segmented.

### SUMMARY OF THE INVENTION

It has become common to set a link to a document such as a word file (file edited using Microsoft Word which is a word processor designed by Microsoft), or a pdf file (portable document format created by Adobe Systems) in an HTML document in order to enable to directly browse or edit the document from a browser. However, a cellular phone where software necessary to browse or edit the document in such formats is not installed or can not be installed does not allow a user to browse the file from the document link in the HTML document. Even with the technique disclosed in Japanese Patent Application Laid-Open No. 2002-351736, the word file or the pdf file can not be browsed from the document link in the HTML document.

Accordingly, an object of the presently disclosed subject matter is to provide a document link converting server, a document link converting system and a document link converting method for enabling a mobile terminal on which software necessary to open a linked document from the HTML document (or other documents described using markup-language) is not installed, to display the linked document.

In order to achieve the above-mentioned object, the document link converting server according to a first aspect of the presently disclosed subject matter includes: a web page acquiring device which acquires a web page based on a request from an access source; a converting device which converts a document link in the web page based on a document link conversion rule; a web page providing device which provides the web page with the converted document links to the access source; a link information acquiring device which acquires information on the document link selected by the access source from the web page with the converted document link; an image data creating device which creates an image data for browsing the document data associated with the document link based on the acquired information on the document link; and an image data providing device which provides the image data for browsing to the access source.

According to the first aspect of the presently disclosed subject matter, since the document link acquired in response to the request from the access source is provided to the access source after converting the document link and, when the document link is selected by the access source, the image data for browsing document data corresponding to the selected document link is created and provided to the access source. Thus, even when a terminal where software necessary to open a document file corresponding to the selected document link is not installed, the user can browse the document file using the terminal.

According to a second aspect of the presently disclosed subject matter, the document link converting server according to the first aspect further includes: a conversion rule managing device which manages the document link conversion rule in accordance with a terminal type; a terminal type recognizing device which recognizes a terminal type of the access source; and a conversion rule acquiring device which acquires the document link conversion rule from the conversion rule managing device in accordance with the recognized terminal type.

This enables to convert the document link in the web page depending on the terminal type of the access source.

According to a third aspect of the presently disclosed subject matter, the document link converting server according to the first or the second aspect further includes an image data recording device which records the created image data for browsing.

This enables to make the created image data for browsing reusable.

According to a fourth aspect of the presently disclosed subject matter, in the document link converting server according to the third aspect, the image data for browsing is recorded with respect to each of the recognized terminal types.

This enables to facilitate data retrieval in the case of reusing the created image data for browsing.

According to a fifth aspect of the presently disclosed subject matter, in the document link converting server according to a the first aspect through the fourth aspect, the image data creating device creates the image data for browsing, for each page of the document data, and the image data providing device provides the image data for browsing, page by page.

This enables to send and receive the image data for browsing only necessary pages, resulting in reducing a communication load.

In order to achieve the object, the document link converting system according to a sixth aspect of the presently disclosed subject matter includes comprising a mobile terminal and a server, wherein, the mobile terminal includes: a requesting device which requests a web page to be browsed; a web page data acquiring device which acquires data of the requested web page; a web page display device which displays the web page on a display device based on the acquired data; a document link selecting device which selects a document link from link information in the displayed web page; an image data acquiring device which acquires an image data for browsing a document corresponding to the selected document link; and an image data display device which displays the acquired image data for browsing on the display device, and the server includes: a web page acquiring device which acquires the requested web page; a document link conversion rule managing device which manages document link conversion rules depending on terminal type; a mobile terminal type recognizing device which recognizes a terminal type of the mobile terminal; a document link conversion rule acquiring device which acquires a document link conversion rule in accordance with the terminal type recognized by the conversion rule managing device; a document link converting device which converts a document link in the web page in accordance with the acquired document link conversion rule; a sending device which sends the converted web page to the mobile terminal; a document link information acquiring device which acquires information of the selected document link in the converted web page from the mobile terminal; a browsing image data creating device which creates the image data for browsing the document data corresponding to the document link in accordance with the acquired document link information; and a browsing image data providing device which provides the created image data for browsing to the mobile terminal.

According to the sixth aspect of the presently disclosed subject matter, since the document link of the web page acquired in response to the request from the mobile terminal is provided to the access source after converting the document link and, when the document link is selected at the mobile terminal, the image data for browsing the selected document data is created and provided to the access source Therefore, even when the mobile terminal where software necessary to open the document file is not installed, a user can browse the document file using the mobile terminal.

According to a seventh aspect of the presently disclosed subject matter, in the document link converting system according to the sixth aspect, the mobile terminal displays the image data for browsing, on the display device using an application for browsing a document.

This enables the mobile terminal to display the image data for browsing appropriately.

According to an eighth aspect of the presently disclosed subject matter, in the document link converting system according to the seventh aspect, the application for browsing the document deletes the image data for browsing after the image data is browsed so as not to be able to be displayed again.

This enables to secure security of the image data for browsing.

According to a ninth aspect of the presently disclosed subject matter, in the document link converting system according to the seventh or the eighth aspect, the application for browsing the document is provided from the server to the mobile terminal.

This enables the mobile terminal to acquire the application for browsing the document appropriately.

In order to achieve the object, the document link converting method according to a tenth aspect of the presently disclosed subject matter includes: acquiring a web page upon a request from an access source; converting a document link in the web page based on a document link conversion rule; providing the web page with the converted document link to the access source; acquiring information of a selected document link in the web page with the converted document link from the access source; creating an image data for browsing document data associated with the document link based on the acquired information of the selected document link; and providing the image data for browsing to the access source.

According to the presently disclosed subject matter, even when a mobile terminal including a cellular phone where software necessary to open a document file is not installed, a user can browse the document file linked from an HTML document using the mobile terminal.

### BRIEF DESCRIPTION OF THE DRAWINGS

FIG. 1A illustrates an example of general structure of a document link converting system 100;

FIG. 1B illustrates an example of a table describing contents of processes corresponding to each reference numeral shown in FIG. 1A;

FIG. 2 is a flow chart illustrating processes of the document link converting system 100;

FIG. 3 illustrates a document link before conversion and a document link after conversion;

FIG. 4 illustrates a structure of a data base in a document converting server 24; and

FIG. 5 is a flow chart illustrating processes performed by the document link converting system 100.

### DETAILED DESCRIPTION OF THE PREFERRED EMBODIMENTS

In the following, embodiments of the presently disclosed subject matter will be described with reference to the accompanying drawings.

### First Embodiment

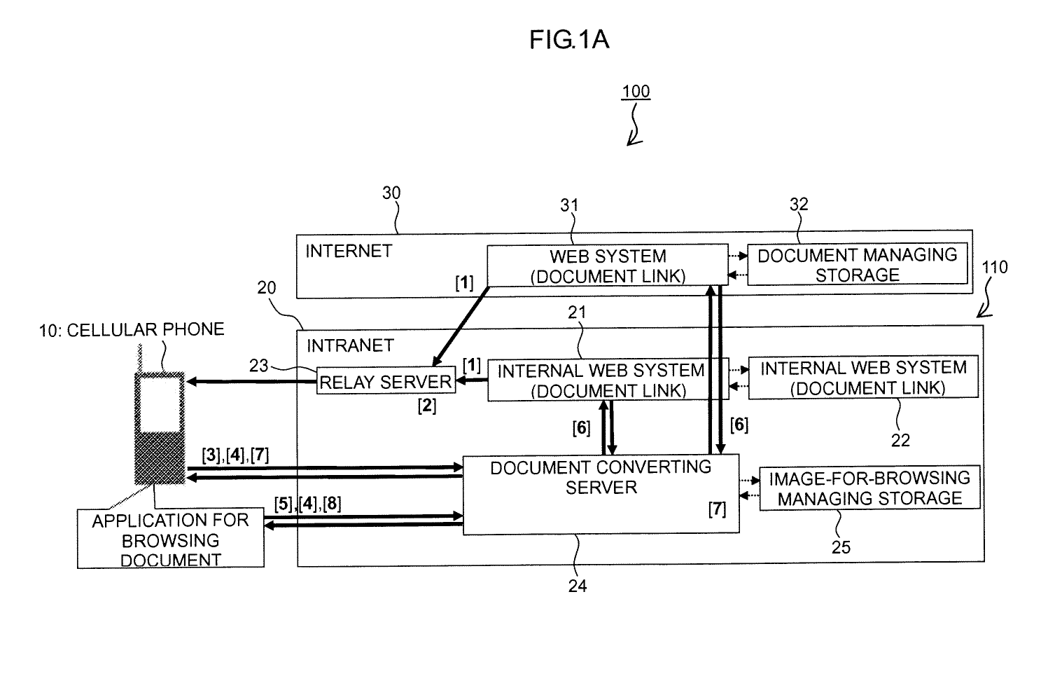

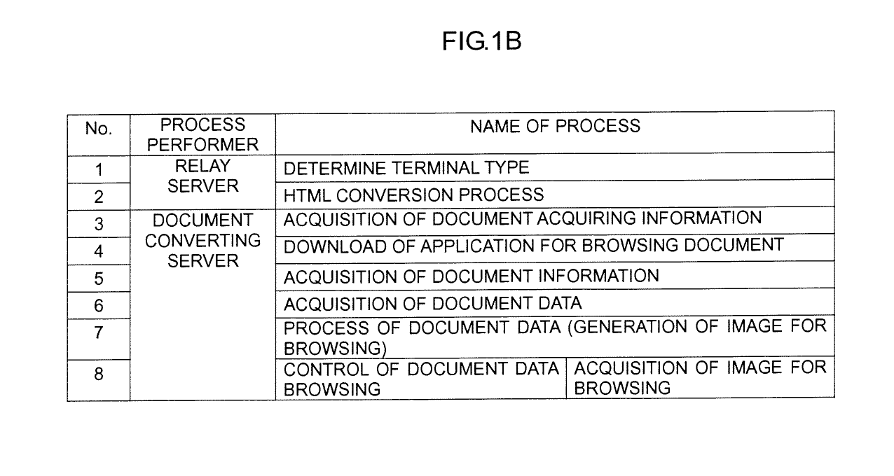

FIG. 1A illustrates an example of general structure of a document link converting systems 100 according to the present embodiment. FIG. 1B is a table describing contents of processes corresponding to each reference numeral shown in FIG. 1A.

As shown in FIG. 1A, the document link converting system 100 is configured to include a cellular phone 10 operated by a user, a document link converting server 110, a web system 31, a document managing storage 32 and the like. The document link converting server 110 which is located in an intranet 20, includes an internal web system 21, a document managing storage 22, a relay server 23, a document converting server 24, and a image-for-browsing managing storage 25. The web system 31 and the document managing storage 32 are located in a wide area network such as the Internet 30.

The cellular phone 10 is connected to the document link converting server 110 to be able to communicate therewith using a predetermined protocol via a network. The network may be an internet, a leased communication line, or a VPN (Virtual Private Network). The document link converting server 110 sends a web page requested by the user's cellular phone 10 to the cellular phone 10 after converting a document link.

The cellular phone 10 is equipped with a communication unit (not shown), a display unit (not shown), and a function required for functioning as a normal cellular phone (such as a function required for verbal communication, a function required for sending/receiving an electronic mail or the like, and a function required for browsing a website).

The intranet 20 is an in-house independent network and is connected to the internal web system 21, the relay server 23, and the document converting server 24 to be able to communicate therewith.

The internal web system 21 manages the intranet 20 in general, performs various services in response to a request from a client, and holds a website (an HTML document or the like) which is internally viewable and of which documents are linked together.

The document managing storage 22 is a mass storage device such as a hard disk device where many internal documents including a word file and a pdf file are recorded. The document managing storage 22 records a document file associated with the document link of the HTML document or the like that the internal web system 21 holds and is configured to be accessible from the internal web system 21.

The relay server 23 is a server which relays communication between the cellular phone 10 and the internal web system 21 and converts the web page requested by the cellular phone 10 in parallel with determining a terminal type of the cellular phone which is a destination of the communication. The details of the converting process will be described hereinafter.

And, the relay server 23 relays communication between the cellular phone 10 and the external web system 31 via the internet 30. The web system 31 is a system which provides service on the Web via the Internet and the relay server 23 can also acquire the document file from the document managing storage 32 via the web system 31.

The document converting server 24 creates the image for browsing based on the document file requested by the cellular phone 10. The details of creating the image for browsing will be also described hereinafter.

The image-for-browsing managing storage 25 is a mass storage device which records the image for browsing created by the document converting server 24 and may be shared with a mass storage device of the document managing storage 22.

Note that, though only one cellular phone 10 is described in FIG. 1A, there are many cellular phones 10 which can communicate with the document link converting system 100 and each cellular phone can communicate individually via the relay server 23. And there are many external web systems 31 on the internet 30.

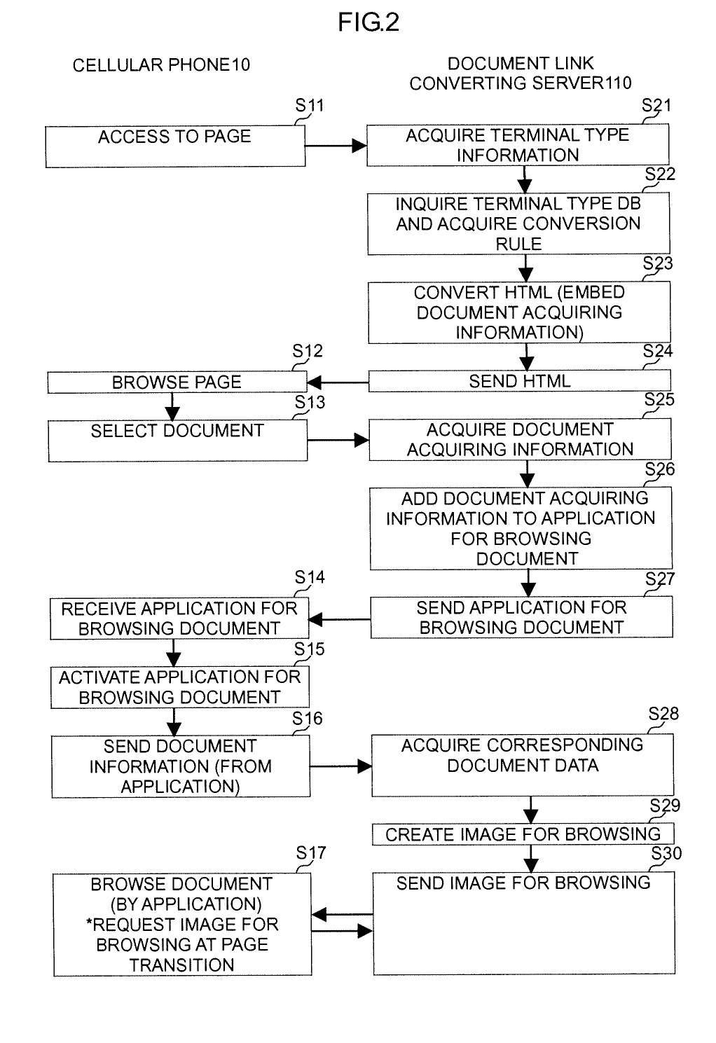

Next, operation of the document link converting system 100 configured in the above-mentioned manner will be described with reference to FIG. 2.

The user specifies a web page to browse by using an operating unit (not shown) of the cellular phone 10. The communication unit (not shown) of the cellular phone 10 requests the relay server 23 of the document link converting server 110 to access to the specified web page and sends terminal type information to the relay server 23 (step S11).

The relay server 23 acquires the sent request of the access to the web page and the terminal type information (step S21), and determines an access authorization of the cellular phone 10. If the cellular phone is the one registered by an administrator's function, the relay server 23 inquires a terminal type managing data base (not shown) and acquires a conversion rule for the web page in accordance with the terminal type of the cellular phone (step S22) since the document file which can not be browsed and an appropriate application for browsing the document which will be described hereinafter varies with the terminal type of the cellular phone.

Next, the relay server 23 acquires the HTML document corresponding to the acquired web page based on the access request of the acquired web page. If the corresponding web page is located within the internal web system 21 of the intranet 20, the relay server 23 acquires the corresponding web page from the internal web system 21. If the corresponding web page is located within the external web system 31 of the internet 30, the relay server 23 acquires the corresponding web page from the external web system 31.

In addition, the relay server 23 converts the HTML document corresponding to the access request of the web page (i.e., the HTML document which the cellular phone 10 requests to access) based on the conversion rule for the web page in accordance with the terminal type information acquired at step S22 (step S23). In other words, the relay server 23 analyzes a syntax described in the HTML document corresponding to the access request of web page and embeds information (document acquiring information) for acquiring the document at a location of a corresponding link if the link to a document file which can not be browsed by the terminal type of the cellular phone 10 is described.

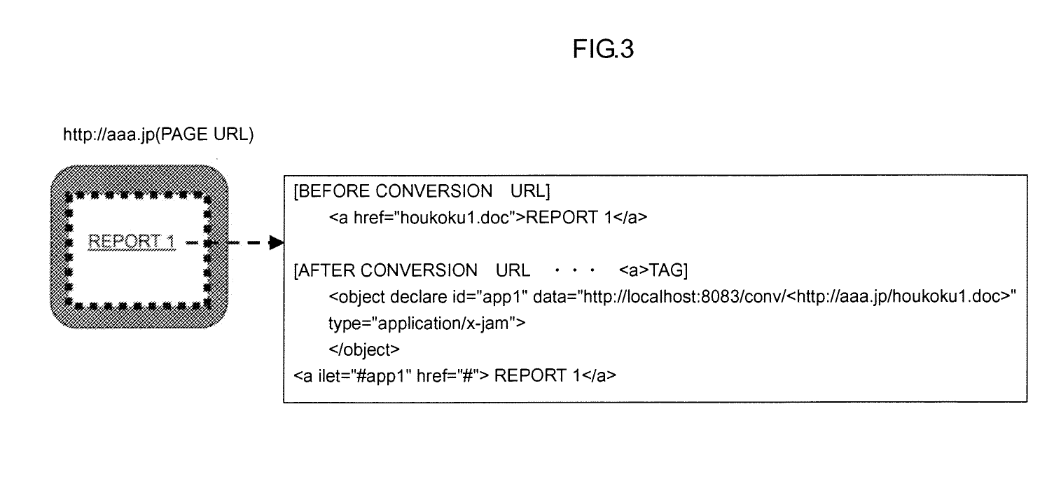

FIG. 3 shows an example of the document link described in the HTML document before conversion and an example of the document link described in the HTML document after conversion. As shown in FIG. 3, in the HTML document of which URL is “http://aaa.jp” before conversion, a link to a document file (linked document file) whose file name is “houkoku1.doc” is embedded to a character string of “report 1.” The document file whose name is “houkoku1.doc” is a word file and can not be browsed by the terminal type of the user's cellular phone 10.

The relay server 23 embeds a tag for activating the application of which ID is “appl” into the part where “houkoku1.doc” which is the linked document file. The “appl” application is defined by an object command in advance and is configured to be downloaded to the cellular phone 10 and to be activated if display of “report 1” is selected. When the “appl” is activated, the “appl” application acquires the data for browsing (data for browsing “houkoku1.doc) corresponding to “houkoku1.doc” and displays the data for browsing on the display unit of the cellular phone 10.

The relay server 23 sends the converted HTML document as the data corresponding to the requested web page to the cellular phone 10 (step S24).

The cellular phone 10 receives the converted HTML document and displays the converted HTML document on the display unit (not shown) with using a browser. As described above, the user can browse the requested web page (the HTML document) (step S12).

Under the condition mentioned above, the document file linked with the displayed web page can be selected. The user selects a desired document file by using the operating unit (not shown) of the cellular phone 10 (step S13).

When the link to the document file is selected, the cellular phone 10 sends document acquiring information (data information shown in FIG. 3) embedded in the selected link. The document converting server 24 of the document link converting server 110 acquires the document acquiring information sent from the cellular phone 10 (step S25). Information about the document file to be acquired and the application for browsing the document is described in the document acquiring information.

The document converting server 24 acquires the application for browsing the document, appends the document acquiring information acquired at step S25 to the application for browsing the document (step S26), and then sends the application for browsing the document to the cellular phone 10 (step S27).

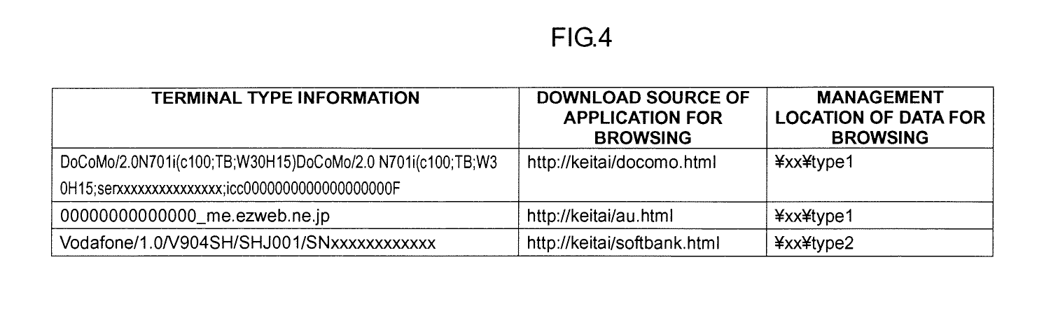

FIG. 4 illustrates a structure of a data base in the document converting server 24. As shown in FIG. 4, a download source (storing location) of the application for browsing the document and a location (management location) where the data for browsing (the image for browsing) is managed are recorded in an associated manner with the terminal type of the cellular phone. The explanation as to data for browsing will be described later. The document converting server 24 acquires the application for browsing the document based on the information about the download source of the application for browsing the document in the data base.

The cellular phone 10 receives the application for browsing the document (step S14), activates the application immediately after receiving the application (step S15), sends the document acquiring information appended to the application from the activated application for browsing the document to the server, and requests the document data (step S16).

The document converting server 24 which receives the document acquiring information acquires the corresponding document data (step S28). If the corresponding document data is recorded in the storage 22 of the intranet 20, the document converting server 24 acquires the corresponding document data from the storage 22 via the internal web system. If the corresponding document data is stored in the storage 32 of the interne 30, the document converting server 24 acquires the corresponding document data from the storage 32 via the web system managing the storage 32.

The document converting server 24 creates the image for browsing of the first page in the document from the acquired document data (step S29). The image for browsing is created in JPEG (Joint Photographic Experts Group) format or BMP (Bit Map) format in accordance with the terminal type so that the image can be displayed on the display unit of the cellular phone 10. The document converting server 24 records the image for browsing in the storage 25. When recording the image for browsing in the storage 25, the image for browsing is recorded based on the place for managing the image for browsing in the data base as depicted in FIG. 4.

Note that, since the image for browsing are recorded in a management location in accordance with the terminal type as described above, when a cellular phone of the same terminal type request to browse the same document, the image for browsing may be acquired from the management location of the image for browsing, instead of creation of the image for browsing.

Finally, the image for browsing the first page is sent to the cellular phone 10 (step S30).

The cellular phone 10 which receives the image for browsing displays the image for browsing on the display unit with using the application for browsing the document (step S17). Though the cellular phone 10 can not display the document file such as the word file or the pdf file, the cellular phone 10 can display the image for browsing on the display unit since the image for browsing in displayable format is sent to the cellular phone 10.

When an operation to perform page transition of the document is performed later, the cellular phone 10 requests the image for the corresponding page again. As for the above-mentioned case, the document converting server 24 is just required to send only the image for browsing the requested page since the application for browsing the document has already been downloaded to the cellular phone 10.

Since only the image for browsing the necessary page is sent and received as mentioned above, communication of the image data for browsing unnecessary pages are eliminated, thereby reducing load of the document link converting server 110. Note that the document converting server 24 may collectively send the image data for browsing all of the pages associated with the document file to the cellular phone 10 if necessary.

Since the application for browsing the document is configured to make the image data for browsing manageable and browsable per page (in page unit, or page by page), the user can browse the image data for browsing per page and in page sequence in the same manner that the user browses the document file with using a personal computer.

In addition, the application for browsing the document has a function to disable storage of the browsed image in the cellular phone 10 in order to secure security of the image for browsing. In other words, the image for browsing recorded in a memory for the display unit is deleted after completion of browsing (display) and does not remain in the cellular phone 10. Note that, since it is not required to care about security of the document data acquired from the external storage 32 of the internet 30 unlike the document acquired from the internal storage 22, the document data acquired from the external storage may not be deleted from the memory.

As described above, even in the case that there is a link to a word file or a pdf file which can not be browsed at the cellular phone is included in an HTML document file, the same content as that of the word file or the pdf file can be browsed at the cellular phone because the server changes the destination of the link, and converts the liked document file (word file or pdf file) to an image and sends the image to the cellular phone when the user of the cellular phone selects the document link.

Note that, though the present embodiment describes the case that the requested web page is the HTML document, the presently disclosed subject matter is applicable to the case that the requested web page is a content file such as an XML (Extensible Markup Language), and an SML (Simple Markup Language).

According to the present embodiment, the server creates the image for browsing the requested document in page unit and sends it; however, the server may create images for browsing all of the pages of a document and send all the images for browsing when the document is selected. In the case mentioned above also, the images for browsing do not remain in the cellular phone 10 after completion of browsing the images.

Further, though web page conversion rules are prescribed (described) depending on the terminal type information according to the present embodiment, one certain conversion rule not associated specifically with the terminal type may be applied. In this case, a link to document data is converted to a link to the document converting server 24 appended with location information of the document data. When the document link is selected by the user of the cellular phone 10, the document converting server 24 determines the terminal type of the cellular phone 10 and sends the application for browsing the document corresponding to the determined terminal type information to the cellular phone 10.

### Second Embodiment

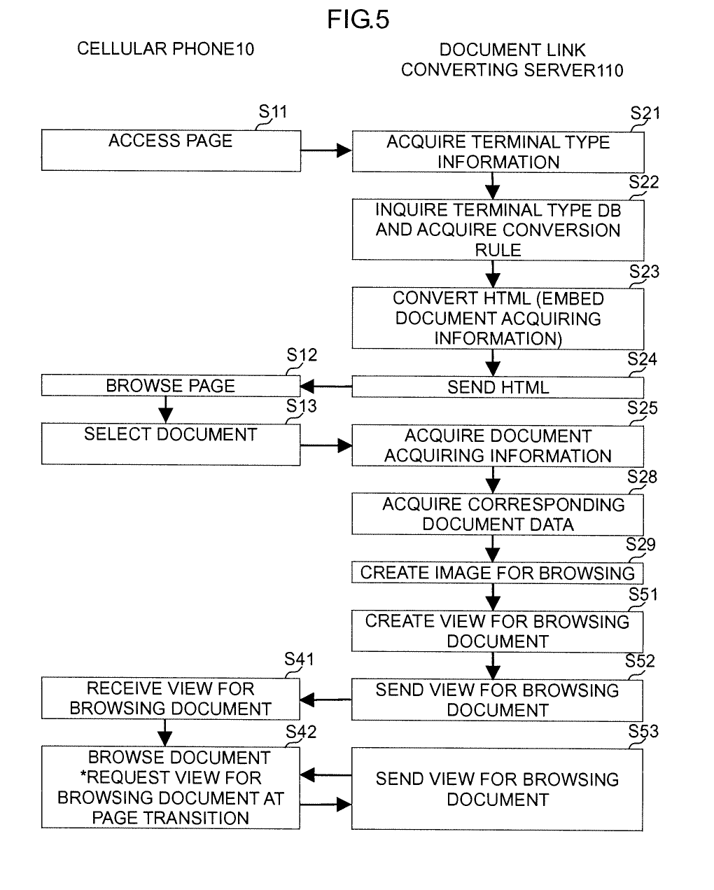

Operation of a document link converting system 100 according to a second embodiment will be described with reference to FIG. 5. The same operations as those described in FIG. 2 are denoted by the same reference characters and detail description thereof will be omitted. According to the second embodiment, a cellular phone 10 displays a view (document browsing view) for browsing a document such as an HTML document corresponding to the document data on a display unit (not shown) instead of using an application for browsing the document.

The operations up to the operation where a document converting server 24 creates the image for browsing the selected document file in response to selection of the document link by the cellular phone 10 are the same as those described in the first embodiment (step S21 to step S29).

Then, the document link converting system 100 according to the second embodiment creates the document browsing view (step S51) and sends the document browsing view the cellular phone 10 (step S52).

The cellular phone 10 receives the document browsing view and displays the received the document browsing view on the display unit (not shown) (step S42). A user can view the same content as the designated word file or pdf file by browsing the document browsing view.

Thereafter, when the user instructs page transition of the corresponding document, the cellular phone 10 requests the document converting server 24 to send the document browsing view of a destination page specified by the page transition. The document converting server 24 creates the document browsing view of the requested page and sends the document browsing view to the cellular phone 10 (step S53).

With the configuration described above, even in the case that the application for the browsing the document is not used, the user can browse the same content as the designated word file or pdf file by browsing the document browsing view.

Though the cellular phone 10 is used for describing the present specification as an example of equipments the user uses, the presently disclosed subject matter can be applied to other equipments such as a PDA and but can not display a word file or a pdf file.

In the following embodiments, a cellular phone 10 is employed as an example of a mobile terminal; however, it should be understood that the presently disclosed subject matter is applicable to other types of mobile terminal including a so-called net PC, portable game machine with network connecting function, PDA (personal digital assistant), a digital camera which can be connected to the Web and so on, which are connectable to a web but cannot browse Web.

What is claimed is:

1. A document link converting server, comprising:
a web page acquiring device which acquires a web page based on a request from an access source;
a converting device which converts a document link in the web page based on a document link conversion rule;
a web page providing device which provides the web page with the converted document links to the access source;
a link information acquiring device which acquires information on the document link selected by the access source from the web page with the converted document link;
an image data creating device which creates an image data for browsing the document data associated with the document link based on the acquired information on the document link; and
an image data providing device which provides the image data for browsing to the access source.

2. The document link converting server according to claim 1, further comprising:
a conversion rule managing device which manages the document link conversion rule in accordance with a terminal type;
a terminal type recognizing device which recognizes a terminal type of the access source; and
a conversion rule acquiring device which acquires the document link conversion rule from the conversion rule managing device in accordance with the recognized terminal type.

3. The document link converting server according to claim 1, further comprising:
an image data recording device which records the created image data for browsing.

4. The document link converting server according to claim 3, wherein the image data for browsing is recorded with respect to each of the recognized terminal types.

5. The document link converting server according to claim 1, wherein
the image data creating device creates the image data for browsing, for each page of the document data, and
the image data providing device provides the image data for browsing, page by page.

6. A document link converting system comprising a mobile terminal and a server, wherein,
the mobile terminal comprises:
a requesting device which requests a web page to be browsed;
a web page data acquiring device which acquires data of the requested web page;
a web page display device which displays the web page on a display device based on the acquired data;
a document link selecting device which selects a document link from link information in the displayed web page;
an image data acquiring device which acquires an image data for browsing a document corresponding to the selected document link; and
an image data display device which displays the acquired image data for browsing on the display device, and
the server comprises:
a web page acquiring device which acquires the requested web page;
a document link conversion rule managing device which manages document link conversion rules depending on terminal type;
a mobile terminal type recognizing device which recognizes a terminal type of the mobile terminal;
a document link conversion rule acquiring device which acquires a document link conversion rule in accordance with the terminal type recognized by the conversion rule managing device;
a document link converting device which converts a document link in the web page in accordance with the acquired document link conversion rule;
a sending device which sends the converted web page to the mobile terminal;
a document link information acquiring device which acquires information of the selected document link in the converted web page from the mobile terminal;
a browsing image data creating device which creates the image data for browsing the document data corresponding to the document link in accordance with the acquired document link information; and
a browsing image data providing device which provides the created image data for browsing to the mobile terminal.

7. The document link converting system according to claim 6, wherein the mobile terminal displays the image data for browsing, on the display device using an application for browsing a document.

8. The document link converting system according to claim 7, wherein the application for browsing the document deletes the image data for browsing after the image data is browsed so as not to be able to be displayed again.

9. The document link converting system according to claim 7, wherein the application for browsing the document is provided from the server to the mobile terminal.

10. A document link converting method, comprising:
acquiring a web page upon a request from an access source;
converting a document link in the web page based on a document link conversion rule;
providing the web page with the converted document link to the access source;
acquiring information of a selected document link in the web page with the converted document link from the access source;
creating an image data for browsing document data associated with the document link based on the acquired information of the selected document link; and
providing the image data for browsing to the access source.
